(19) United States
(12) Patent Application Publication
(10) Pub. No.: US 2012/0159356 A1
(43) Pub. Date: Jun. 21, 2012

(54) Enhanced World Wide Web-Based Communications

(76) Inventor: Ryan Steelberg, Irvine, CA (US)

(21) Appl. No.: 13/186,635

(22) Filed: Jul. 20, 2011

Related U.S. Application Data
(60) Provisional application No. 61/467,591, filed on Mar. 25, 2011.
(60) Provisional application No. 61/412,989, filed on Nov. 12, 2010.

(51) Int. Cl. G06F 15/173; G06F 3/01

(52) U.S. Cl. 715/760; 709/225; 709/224

(57) ABSTRACT

A system and method for providing a browsing widget, comprising a javascript component that obtains at least one permission regarding the primary content and that receives browsing content produced remotely from a second one of the javascript component as forwarded over at least one network to said javascript component.

### RELATED APPLICATION

This application is related to and takes priority from U.S. provisional patent application Ser. No. 61/467,591 entitled APPARATUS, SYSTEM AND METHOD FOR A MEDIA ENHANCEMENT WIDGET, filed Mar. 25, 2011, the entirety of which is included herein by reference; and U.S. provisional patent application Ser. No. 61/412,989, entitled APPARATUS AND SYSTEM FOR REAL TIME INTERACTION WITH THIRD PARTY WEB BROWSING, filed Nov. 12, 2010, the entirety of which is incorporated herein by reference.

### BACKGROUND

Use of the Internet has matured to the point where information and data processing resources accessible via the Internet are regularly relied on by users to enhance many aspects of their respective lives. The large majority of the Internet communications that most users are familiar with take place over the world wide web. Typically, users access the web using a web browser that runs on a computing terminal, such as a personal computer, web enabled tablet, smart phone, or the like. The web browser is used to access web servers that host web pages, typically containing hyperlinks to jump from one web page to another, and/or controls to invoke applications that run on servers. A user will “surf” the web by entering website names into the browser or following hyperlinks to locate web pages comprising text and/or audio/visual media of interest to the user. The web browser is also used to access web enabled applications, typically through the use of visual controls such as buttons, check boxes, drop down lists, and the like placed on web pages to trigger some sort of processing by the application. For example, processing in the form of shopping for goods and services via the web is commonplace. A web-based virtual storefront typically provides a search function to search for desired items that are generally displayed as images with information about the items, a virtual shopping basket to store selected items for purchase, and a checkout procedure that completes the purchase of the selected items and initiates shipping of the purchased items to a designated location.

The internet has also long been used as a platform for communications such as emails, text messaging, voice over IP (VoIP) calls, video conferencing, and the like. In addition, web-based social networking sites allow users to communicate within social groups, post their opinions and creative works, etc. Mechanisms also exist for users to communicate in real time over the web, such as with instant text messaging, audio and/or video conversations between two or more parties, or broadcasting text and/or audio/visual messages, programming, and the like from a broadcaster to a plurality of listeners/viewers. In short, the Internet, and more particularly the web have permeated many aspects of users lives.

However, although there are many web-related applications and functions available to users, they generally operate independently from one another. Most applications are not designed to cooperate with other applications. Moreover, switching from one application to another can be inconvenient. Consequently, using a second application in a way that relates to the subject matter of a first application is generally clumsy, requiring several steps including mouse clicks, keystrokes, and typing words, names, or phrases, and the depending on the context.

Further, there is currently no way to engage in true “social browsing,” i.e., browsing by a first person that is not only viewable to a second person, but that can be interactively experienced by the second person as if the second person were directing the browsing. Rather, presently available social media provide only the capabilities to view a surfing experience by another person, and/or to follow an invitation to series of suggested links that arrive at the same location as another person.

In view of the foregoing, it is desirable to have a framework that provides for the cooperation of otherwise unrelated applications, eases switching from one application to another, and generally mitigates the shortcomings of the prior art. It is also desirable to provide a framework that facilitates transactions, user-to-user communications, and the creation of new relationships and new ways for users to interact, such as by true social browsing.

### SUMMARY

Systems and methods are described that provides a fully interactive social browsing environment and experience, and that provides a framework for coordinating the operation and interaction of otherwise unrelated applications with simplistic switching and interweaving of one web-enabled application to another, and that facilitates transactions, user-to-user communications, and the creation of new relationships and new ways for users to interact online. These systems and methods generally mitigate the shortcomings of the prior art and provide a true social browsing experience.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings, like numerals represent like elements, and:

FIG. 1 depicts an exemplary computing terminal for use in accordance with the described system and methods;

FIG. 2 illustrates an exemplary illustrative networked computing environment;

FIG. 3 illustrates a top-line interface in accordance with the present invention;

FIG. 4 illustrates an accessing of a social browsing experience via a top line interface;

FIG. 5 is a diagram that illustrates the tracking widget system in accordance with the present invention;

FIG. 6 is a diagram that illustrates the tracking widget system in accordance with the present invention;

FIG. 7 is a screen shoot that illustrates the tracking widget system in accordance with the present invention;

FIG. 8 is a screen shoot that illustrates the tracking widget system in accordance with the present invention;

FIG. 9 is a screen shoot that illustrates the tracking widget system in accordance with the present invention;

FIG. 10 is an illustration of the graphical user interface of the tracking widget system in accordance with the present invention;

FIG. 11 is an illustration of a system for social browsing according to the present invention;

FIG. 12 is an illustration of a system for social browsing according to the present invention;

FIG. 13 illustrates a java script iFrame component widget in association with the present invention;

FIG. 14 is an exemplary illustration of a social browsing aspect according to the present invention;

FIG. 15 illustrates a first browser acting as a social browsing dashboard;

### DETAILED DESCRIPTION

It is to be understood that the figures and descriptions of the present invention have been simplified to illustrate elements that are relevant for a clear understanding of the present invention, while eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

In an embodiment of the present invention, a cookie, widget, or similar coded software item may be used to track, report, broadcast or receive both real time and historical browser activities. Such tracking may include, for example, each and every URL encountered by the browser for the purpose of syndicating to others a real time experience or stream based on such browsing. The tracking may include temporal characteristics of the browsing done by a user of the browser, the attributes of the user, and/or the attributes of the device from which the browsing has or is taking place. Thus, tracking of browser use may be inclusive of mobile and semi-mobile computing devices.

Social browsing, as defined herein, is internet browsing, web surfing, site visitation, and the like, wherein a first user controls the browser of at least one other user by the action taken by the first user in the browser of the first user (the “first browser” or “control browser”), and further wherein the virtual locations visited by the first user and the second user, and by the first browser and the second user's browser (the “second browser”), are accessible by a user action from the first user or second user to the second browser. More particularly, the first user may control the site visitations of the second browser, but, upon any visitation, the second user may access the underlying site to which the second browser was directed by the first user. This stands in contradistinction to the currently available art, in which users may post links, photos, videos, or other embedded content to an account, such as a Facebook or Twitter account, and wherein such information may be accessible to a second user using a second browser, but only by direction of the second browser by the second user to access the first user's information.

Yet further, as part of the social browsing of the present invention, the first user may be able to embed, modify, overlay, or the like, content on or associated with the visited location, and the second user may be able to interact with such content embedded by the first user in the second browser. By way of non-limiting example, the first user may visit, on the first browser, a particular site, and may overlay on that site a video of the first user, taken by a video camera at the first user's computer, wherein the video will overlay on the underlying site in the second browser. In such an embodiment, the browser of the second user may not only show the underlying site for interaction by the second user, but may additionally show the video of the first user in the second browser and allow the second user to interact, such as to pause, fast forward, rewind, or the like, with the first user's video in the second browser.

As such, browsing sessions undertaken by the first user in the first browser may be available to the second browser live, or pre-recorded, such as wherein the second browser is directed to the variety of underlying sites, and provided with the embedded content generated through the surfing of the first browser, but this providing to the second browser is on a time delay from the time at which the actions were performed in the first browser. Thereby, social browsing may make live browsing sessions and embedded content and user interactions available as a type of content, wherein such content may be searchable. For example, a user may search for all social browsing sessions performed by a certain celebrity, or may search for all browsing sessions that mention a particular topic on either the underlying site or in the embedded content. But, in any such instance, upon presentation of the social browsing content to the second browser, the underlying content, i.e., the underlying site and any embedded content, is accessible through the second browser in the same manner as would be accessible to the second browser had the second browser initially been directed to that underlying content by the second user.

Unless specifically stated otherwise, the use hereinthroughout of terms such as “processing”, “computing”, “calculating”, “determining”, “displaying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer, as discussed immediately hereinbelow.

### Illustrative Computing Environment

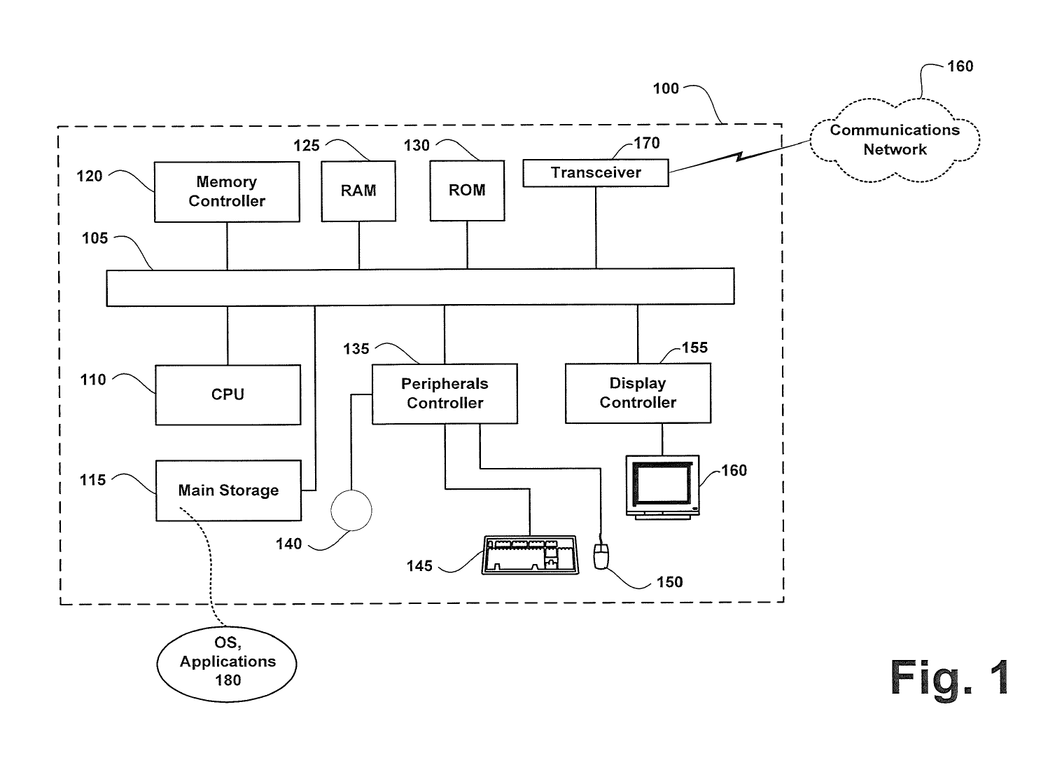

FIG. 1 depicts an exemplary computing terminal 100 for use in accordance with herein described system and methods. For the purposes of illustration, a conventional personal computer (PC) is shown, although other types of computing terminals, such as smart phones, computing tablets, and the like may also be used. The computing terminal 100 is capable of executing an operating system and computing application 180, such as by execution of computer-readable instructions from a computer readable medium. Computing, application 180 is a web browser that may comprise one or more addons such as snapins, plugins, extensions, themes, scripts, applets, and the like. Application 180 comprises sets of instructions (software), which are executed by processor 110 to perform one or more operations, functions, and/or procedures. Processor 110 is generally an integrated circuit microprocessor, referred to as a central processing unit (CPU).

In operation, CPU 110 fetches and executes the computer-readable instructions from the computer-readable medium, such as from main storage device 115 which may be a hard disk drive (HDD), solid state drive, optical drive, or the like, and transfers data to and from other resources via the computer's main data-transfer path, system bus 105. A computer readable medium may include any mechanism for storing or transmitting information in a form readable by a machine (e.g., a computer). By way of non-limiting example only, a machine-readable medium may include a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals), and the like.

The system bus may connect various components of the computing terminal 100 and defines the internal medium for data exchange. Other data storage devices coupled to the system bus 105 may include high-speed random access memory (RAM) 125 and read only memory (ROM) 130. Such memories include elements that allow information to be stored and retrieved. ROM 130 generally stores data such that it can only be read but not modified, whereas RAM 125 stores data that may be read, modified, and/or added to by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, computing terminal 100 may comprise peripheral controller 135, such as a Peripheral Component Interconnect (PCI) or Universal Serial Bus (USB) controller, responsible for communicating instructions and other data between system bus 105 and internal and/or external devices such as speaker 140, keyboard 145, and mouse 150, although other peripheral devices (not shown) may also be used. Display 160, which is controlled by a display controller 155, is used to display visual output of the computing terminal 100. Such visual output may include text, graphics, animated graphics, and video. The display controller 155 includes elements that generate a video signal that is sent to display 160 for display, often coordinated with a corresponding sound signal that is sent to speaker 140. Further, the computing terminal 100 can comprise a network adaptor, modem, and/or other transceiver 170, which may be wired or wireless, to connect the computing terminal 100 to an external communication network 160.

### Illustrative Networked Computing Environment:

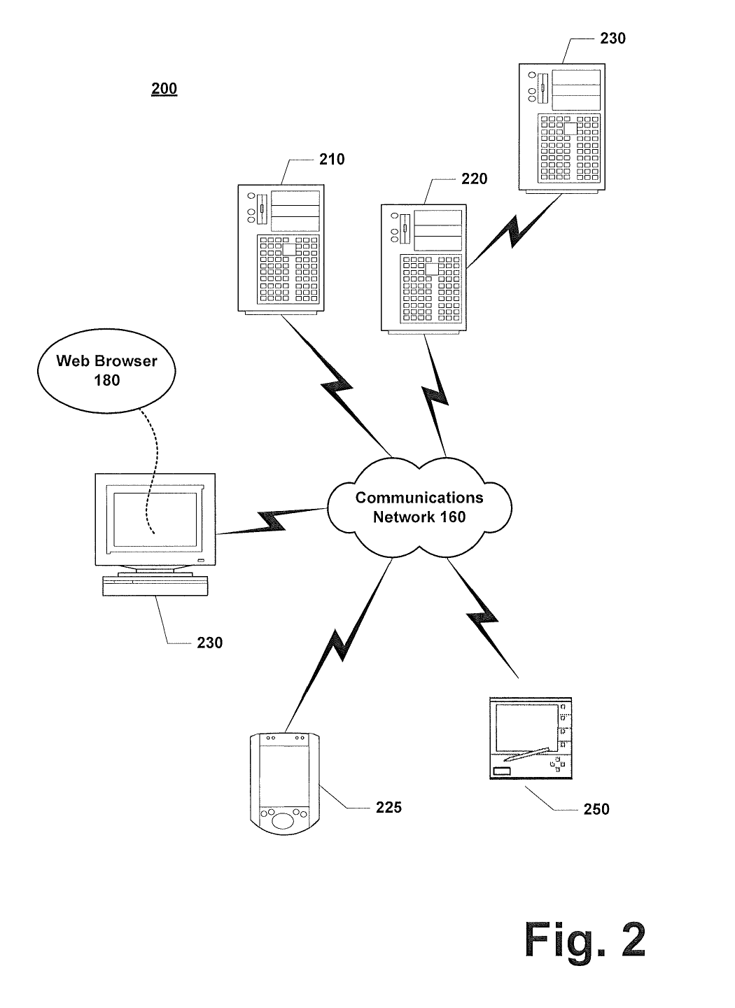

Computing terminal 100 can be deployed as part of a computer network. In general, the above description of a computer terminal can also be applied to server computers deployed in a network environment. FIG. 2 illustrates an exemplary illustrative networked computing environment 200, comprising a plurality of servers in communication with a plurality of client computing terminals via one or more communications networks, in which the herein described apparatus and methods may be employed. As shown in FIG. 2, servers 210, 220, 230 may be interconnected with client computer terminals such as PC 100, smart phone 240, tablet personal computer 250, and the like, via communications network 160, which may include one or more of the Internet, wireless telephone networks, WANs, LANs, and/or other communications networks. In an environment in which the communications network 160 includes the Internet, for example, the clients and servers may communicate using any of a number of known protocols and protocol suites such as hypertext transfer protocol (HTTP), file transfer protocol (FTP), simple object access protocol (SOAP), wireless application protocol (WAP), remote framebuffer protocol (RFB), Remote Desktop Protocol (RDP), cryptographic protocols, and the like. Server computers may be tangible machines, and may also include one or more Virtual Machines (VMs) controlled by a hypervisor, that mimic the operation of tangible servers but which are hosted in a “server farm” comprising a large number of cooperating processors, memory, storage devices, and supporting hardware. An arbitrary number of cooperating tangible servers and server farms hosting VMs can constitute a so-called “cloud computing” environment, in which resources are allocated in accordance with the demands of the tasks at hand.

Each client computing terminal 100, 240, 250 can be equipped with web browser application 180 operable to support one or more computing applications to gain access to servers 210, 220, 230. Client web browsers can include one or more addons, operating to enhance the functionality of the web browser.

In operation, a user interacts with the web browser running on a client computing terminal to obtain access to desired data and computing applications provided by one or more servers, via the Internet. Communications between the servers and the client terminals is accomplished via exemplary communications network 160. A user can use a local terminal to request access to specific data and applications that reside in whole or in part on servers 210, 220, 230 and/or other client terminals 100, 240, 250. The data may be communicated between any of the clients and servers for processing and/or storage. For example, clients and servers, individually or in cooperation with other clients and/or servers, can host computing applications and browser addons for the generation, authentication, encryption, and communication of information to provide services and transactions over the web, and can cooperate with other clients, servers, third party service providers (not shown), network attached storage (NAS) and storage area networks (SANs) (not shown), and the like to realize web services and transactions. The servers 210, 220, 230 may be individual tangible machines, or may be virtual machines (VMs) operating in a cloud computing environment.

### Social Browsing Framework

The information and functionality accessible via the web, generally referred to herein as web content, are available from many different sources. In general, those sources are unrelated and operate independently of each other. Typically, they do not coordinate their content with each other, even when that content is inter-related. Indeed, many providers of web content are direct competitors, moreso if they do focus on related content, and consequently have competitive disincentives to cooperate. Even if not competitors, each content provider has an individually defined focus, such as providing general information, current events and news, photos, music, video and other entertainment, social interaction, commerce and other transactions, etc. Thus, even if the subject matter of the content available from various providers is related, the providers generally have no incentive to coordinate their offerings, so in general they have not done so. As a result, end users do not receive benefits that are possible from such coordination, such as more streamlined and convenient web interface, enhanced functionality, or a more engaging user experience. They may have trouble locating the specific information and resources they are interested in, and their experience when moving from one content provider to another can be clumsy and frustrating. This can be especially unsatisfying when the subject matter of the content sought is fast-changing and time sensitive. For example, there may be many sources of information available in connection with a quickly unfolding newsworthy situation, and it may be difficult for an interested user to locate and follow those sources. Or, the latest happenings concerning a user's favorite celebrities, such as entertainers and athletes, their creations and performances both old and new, communications initiated by them or about them, their personal preferences, products that are related to or liked by them, their respective frequent activities, and the like, are quite likely to be accessible from different websites, if available at all, using different web-enabled applications, some of which may be unfamiliar to a user, difficult to locate, or inconvenient to access, and most or all of which make no attempt to coordinate or cooperate with others.

The herein described addons, systems, and methods form a web-based framework that provides an enhanced web browser user interface enabling a simplified, interactive, coordinated social browsing experience for users. This social browsing alleviates the problems with the prior art, at least in that social browsing allows for cooperation between content producers, content receivers, and various web-enabled applications. The enhanced interface of the present invention enables users to interact in real time with images or text presented on any base web page that supports a browser interaction. The enhanced interface presents a unified front-end with which a user can access any of a plurality of addon applications, or any of a plurality of content provided in accordance with addons, and with which the user may be provided with videos, news, social networks, storefronts, custom messages and the like, all without leaving the base, or “underlying,” web page.

In an embodiment, a web browser that does not natively support the enhanced interface may be used to access an Internet site, such as a web page or file transfer protocol (ftp) site, via a provided addon that may be downloaded by a user and installed into the browser. Alternatively, a web browser may be modified, such as by the developer of the browser software, to incorporate the herein disclosed enhanced functionality natively without requiring an addon. Preferably, in order to allow for the remotely-controlled, social browsing experience discussed herein, the addon/plugin may embed, for example, a javascript component to allow for remote control via the javascript of a user's browsing experience, such as upon user acquiescence and in the “social browsing” environment discussed herein.

In operation, the addon/plugin may automatically locate certain information on a base web page without user intervention. In an exemplary embodiment, the addon may be configured to locate and highlight text and images of interest, such as text and photographs that contain the name or image of select celebrities, associate those, names and images with browser interface enhancements, and display visual elements that the user can interact with, such as by mousing over an enhanced image, clicking with the mouse on a generated visual element, and the like. The appearance and/or behavior of the enhanced interface elements can be dynamic, and may vary depending on the context and/or in response to specific user and/or automated events. The text and images of interest on a web page may be identified automatically, for example, by analyzing the contents of the page, recognizing in the visible text and metadata of the page the subject of interest, such as by indexing the page contents and comparing the index with a list of subjects in a database, which may be hosted locally or remotely, such as on a server on the web. The layout of the page as currently displayed may also be analyzed locally or remotely, and tags or anchors may be generated with which the addon can place visual elements of the enhanced interface. Those enhancements may be bound to existing elements of the browser or of the web page. Alternatively, the web page may be tagged by its publisher to provide anchors for certain visual and/or functional enhancements. In addition, a mechanism may be provided with which a user can indicate, such as by highlighting using the mouse, text and/or images of interest that are not automatically located. Thereby, the addon can be invoked to provide select functionality associated with the highlighted subject matter.

More particularly, the addon/plugin may be accessed locally by a user to view tracked or recorded remote browsing that occurred, for example, utilizing a web browser similarly associated with the addon/plugin. Moreover, the addon may be accessed remotely with or without the knowledge of the user of the browser for which the browsing information may be obtained. In such a case, the accessing third party may view and/or access all of the information gathered by the addon.

For example, a third-party server may access the addon to determine the browsing preferences and activities for at least one user of the browser at a predetermined interval, such as, for example, daily. As would be understood by those in the art, such information may be used to provide targeted advertising to the user of the browser, optimization of bandwidth by a service provider by comparing the temporal bandwidth requirements required by the user versus other bandwidth demands, and/or the providing of targeted content related to the user's browsing habits, for example.

The addon may generate an icon or other graphical element, such as a button on a toolbar or the like, displayed by default within the browser, that can be used to invoke the display of additional browser elements, for example, to enable additional browser functionality, to make available additional web applications and/or web-based information, and the like. In an embodiment, the button may be used to activate and deactivate the enhancements, or a select subset of the enhancements. In another embodiment, the enhancements may be active by default and the button can be used to invoke select features. For example, the button can invoke the display of a panel containing visual elements that represent data stored in a database, for example, on a web server remote from the client terminal. In the exemplary embodiment that provides celebrity information, the button can be used to invoke the display of a panel anchored on the side of the browser window, referred to herein as a “sidebar”, that can provide user access to a remote database of celebrity images, updated statistics, and other relevant information.

Currently, no web browsers are available that natively support the herein described systems and methods. In a currently preferred embodiment, a user directs a web browser of his computing terminal to a web server, which serves a web page to the client that is displayed in the browser. The web page contains a button or other control with which the user can download an addon/plugin to the web browser. As will be appreciated by those of skill in the art, the addon can take many forms. For example, it can be implemented as a computer software application that is hosted in a browser-controlled environment, such as a Java applet. Such applications may also be developed using a procedural programming language such as C, or an object oriented programming language other then Java, such as Visual Basic or C#.

Additionally or alternatively, the addon may be coded in a browser-supported language such as JavaScript, which relies on the browser to make the addon functional. In the scenarios described herein, the one or more addons may be installed in/downloaded to users' browsers. The addon may enables broadcasts to a remote, broadcast server, may track broadcasted and/or received Uniform Resource Locators (URLs) and/or Uniform Resource Identifiers (URIs), may use AJAX (Asynchronous Javascript and XML, although XML is not actually required to use AJAX)—type events, such as to reproduce the operation of a remote terminal. Thereby, embedded javascript may be embedded within a browser via the addon, such as to enable control of the local browser by a remote browser in the herein described social browsing systems and methods. Thus, the addon may be customized as needed to work with different browsers. For example, the type of browser running on the client may be automatically or manually identified, and the addon that is appropriate for that browser may be downloaded onto the client and installed in the browser.

Such addons or collections of cooperating addons can be used to provide many types of browser enhancements, such as new browser screen elements and, new functionality. New screen elements can include, for example, dedicated viewing areas, icons, buttons, bars, sliders, spinners, menus, list boxes, and other graphical user interface (GUI) widgets of all kinds, and the like. Such elements may be overlaid on a browser window, and may be used to enhance the appearance and/or behavior of pre-existing screen elements, for example, by automatically or manually detecting the size and location of a select element and binding one or more new screen elements to it. The new screen elements may also be bound to corresponding functions, and may be interacted with by a user to invoke those functions, and/or may have a default appearance and default function. The appearance of such screen elements may be static or dynamic, changing in appearance or behavior in response to events triggered automatically, or triggered by a user action. New functionality can include the display of information, presenting choices, launching applications, user identification, user authentication, user authorization, secure communications, remote control of browser operation, etc. Functions may execute solely on the local terminal on which the browser is running; or in concert with cooperating functional components located remotely on one or more servers and/or other clients.

In an exemplary implementation, included with the herein described addon, or provided in an auxiliary addon, “top line” and “sidebar” interactive browser interface elements may be provided. The interface elements may allow for real-time interacting with base web page text and media enhancements and/or sidebar elements described herein. The interface elements may also allow for real-time interacting with a subject of the enhancements, such as by a top-line invite to participate in social browsing with a celebrity of interest, and/or with the concurrent real-time browsing of the subject, such, as a celebrity or other person of interest to the user. As used herein, a top line interface includes at least one indicator widget, such as a button, banner, bar, or the like, preferably visually proximate to the domain listing location or navigation toolbar in a web browser interface, or the top bar or standard toolbar in an application interface. A top line interface, as used herein, stands in contradistinction to a sidebar interface, as also referenced herein. For example, a sidebar interface may serve to aggregate data such as browsing data, from which information of interest may be gathered, whereas a top line interface may serve to provide alternative or enhanced browser or application functionality.

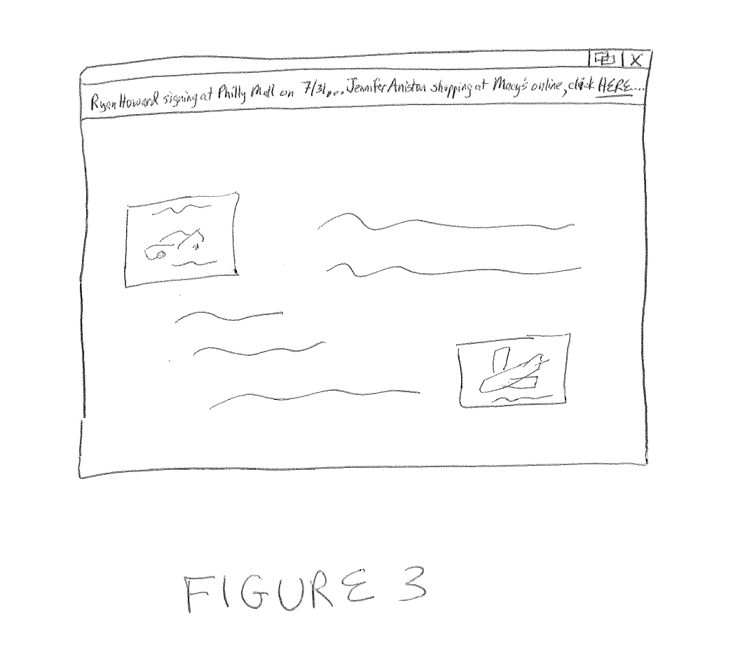

For example, a top line interface provided by an addon in accordance with the foregoing may provide a framework for entry to the social browsing experience in which a third party can control the browsing view of a user, as illustrated in FIG. 3. For example, a control server may receive identification, such as by IP address, of locations surfed by a control browser, and additionally identification of a location of, or content of, any embedded or associated content added to the site content by the control browser. Thereafter, the control server may, in real time or upon recordation of the visited addresses and embedded/associated content, access the javascript component associated with remote browsers that have acquired the addon/plugin and direct those remote browsers to the site. Any embedded/associated content may be added to the site, such as via overlay or widget, for viewing of the site and embedded/associated content in the remote browser window.

For example, a user may designate himself as a follower of a particular celebrity in any of a number of ways, such as by adding the celebrity to a list of favorites. Thereafter, when the celebrity is online and accesses, for example, a web site such as Twitter, Facebook, or another site, the top line interface may indicate to the user that the celebrity is currently online and is open to the social browsing experience. Accessing the top line interface may allow the user to view and/or participate in the celebrity's real-time browsing experience.

In an exemplary embodiment, the top line indicator may indicate to the user that the celebrity is broadcasting a browsing experience, and the user may participate in that browsing experience. Thereby, a celebrity or similar well known personality may broadcast the web browsing session simultaneously to many thousands or even millions of users. Such a broadcast can include broadcasting audio chatting, video chatting, a social browsing experience, a web surfing experience, or the like, wherein the millions of users may be followers of the celebrity. Alternatively, a user may learn that a celebrity or other personality of interest is broadcasting, for example, by navigating to a web page that provides information of broadcasters and links, to their broadcasts, or through one or more top line interface elements such as drop-down lists or other indicators of current or scheduled broadcasts, whereby the user may opt to receive a broadcast even if not a follower.

Moreover, the celebrity or like party that directs the remote browser(s), such as via embedded javascript, may add or embed additional content, such as widgets, to the underlying visited page in the social browsing experience. For example, a celebrity may poll current viewers, or a subset of viewers such as designated followers accessing the broadcast through the top line interface, with regard to an event of the celebrity broadcast, for example, a purchase made by the celebrity during the broadcast, or a live or pre-recorded participation of the celebrity in an activity, or the like. For example, a well known celebrity with a following interested in fashion may broadcast via a webcam or the like a shopping experience, such as via a website associated with the brick and mortar store(s) in which the celebrity is viewable via web-cam live in the dress shop. For example, a female celebrity may shop for dresses, and may poll her followers regarding which dresses the followers prefer, or that they would like the celebrity to wear to the Oscars, or the like. Similarly, the celebrity may broadcast an experience through the celebrity's social webpage, for example wherein the celebrity actively does research regarding a role the celebrity has been offered. In such an exemplary scenario, the celebrity may embed a poll for followers as to whether the celebrity should accept the role based on the shared research experience.

Of course, social browsing aspects of the herein disclosed systems and methods are not limited to followers participating in the experience of a celebrity or other well known personality. For example, any entity can broadcast a browsing or other web based experience through the use of the herein disclosed systems and methods, and thereby other entities can participate in that experience through tools accessed or invoked via the exemplary top line interface described above. Controls may be provided to enable or require a user's browsing experience to be shared or viewable by one or more other designated users. For example, a child's browsing experience may be optionally or mandatorily shared with, or recorded for later viewing by, one or more other identified users, such as the child's parents. Thereby, the parents are able to view and provide oversight of the child's browsing experience, in real time or afterward. Such viewing may occur using a different computing terminal than the child's.

The indication of a real-time session as provided by the top line interface may take various forms. For example, the top line interface may provide a ticker that shows when one or more personalities are currently on-line, thereby allowing followers to participate in the desired viewing experience of any personality that the viewer follows. The indication in the top line interface of which personalities the user wishes to follow may be set, for example, from a search, or from the tracking of user preferences, for example, such as by tools accessed via the sidebar. Likewise, a ticker in the top line interface may indicate what site, or what activity or the like, is presently being viewed or undertaken by a particular personality.

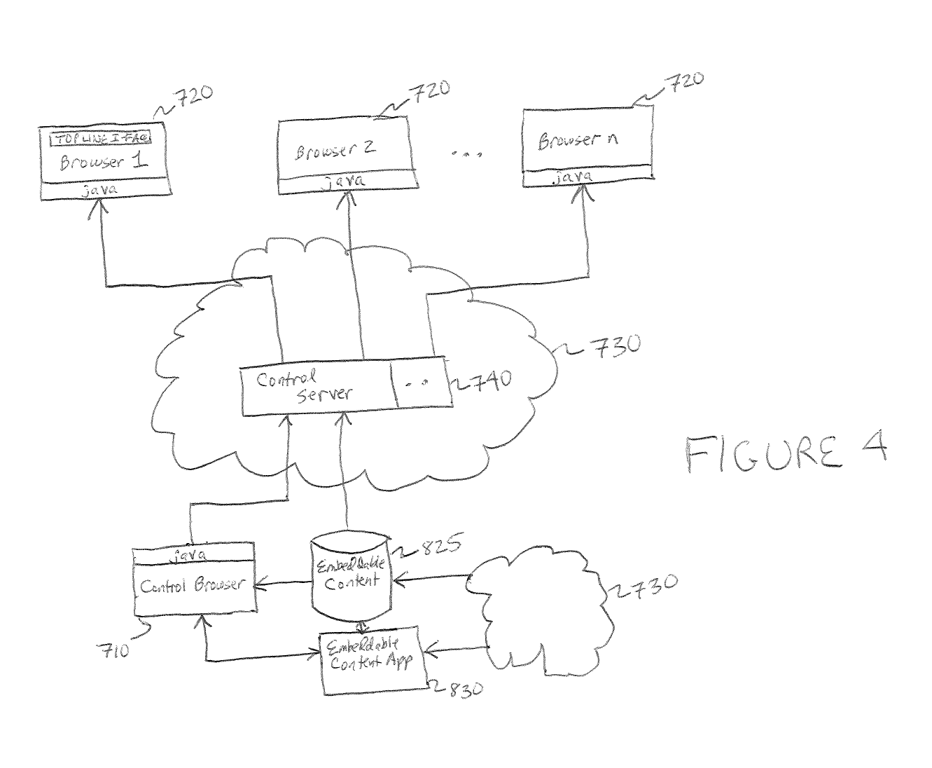

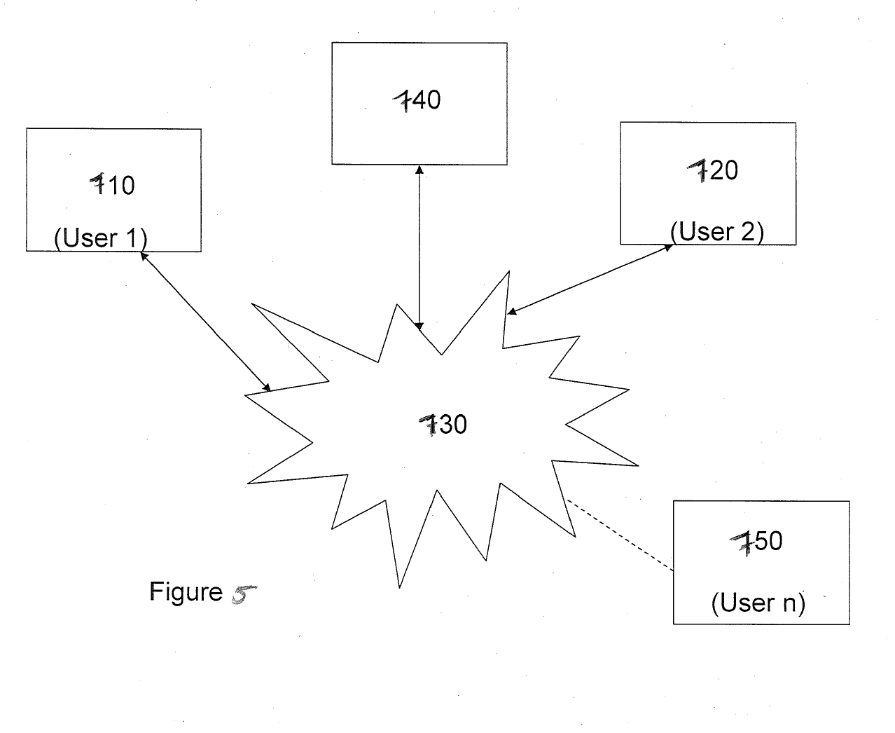

By way of non-limiting example, the top line interfaced discussed herein may be, for example, a ticker, as illustrated in FIG. 3. The ticker may be, for example, stationary or scrolling text that indicates to the user certain interactions related to social browsing. For example, celebrities followed by the user, such as on Facebook or via a sidebar associated with aspects of the instant invention, may have news related thereto scrolled across the ticker. Likewise, if such a celebrity of interest to the user is to engage in a social browsing experience at a particular time, or at a particular date, the user may receive that information on the ticker and further may be enabled to access the social browsing experience by interacting with the ticker. Access to a broadcast social browsing experience via, for example, the top line interface, is illustrated by way of example in FIGS. 4 and 5.

As illustrated in FIGS. 4 and 5, User Browser 710 may be utilizing a browser in association with an addon, such as a tracking widget, of the present invention which may, for example, relay the information correspondent to the browsing of User 710 to User 720. Such remote communication regarding the information collected by the addon/tracking widget may be facilitated directly between the users via a communication systems 730. As would be appreciated by those skilled in the art, communication systems 730 may include the internet, a mutually communicative server, and/or wireless communications, for example. In an embodiment of the present invention, user 720 may be able to view the browsing history of user 710 in either a log format showing, for example, URL addresses, or graphically by allowing the information to facilitate a browser at user 720 to browse and view the tracked browsing of user 710.

In an embodiment of the present invention, the addon/tracking widget may capture at least one screen shot correspondent to at least one web page browsed by at least one user. The tracking widget may further capture a screen shot for each page browsed by the user and may be directed to capture multiple screen shots of a single webpage based on the users interaction with the viewed webpage.

For example, the addon correspondent to the browser of user 710 may capture a screen shot of every individual page visited or browsed by user 710. This information may be delivered to user 720 for viewing. A receiving widget located at user 720 may receive the data from the tracking widget of user 710 and may allow the user 720 to view the at least one screen shot captured by the tracking widget. User 720 may toggle through the at least one individual image provided by the tracking widget and may also be presented with attributes of the user and the browsing done by the user such as, for example, the name of the person browsing, the time at which the screen shot was captured, and/or the duration of time the user spent browsing the webpage depicted in the screen capture.

The present invention may also provide a server 740, such as a broadcast server, which may act as a collection and/or retrieval point, for example, which may facilitate the collection and consolidation of selected tracking widgets. Thus, a third party may instruct server 740 to extract data from any number of users whether specifically predetermined and/or a match for predetermined attributes. In this way, server 740 may allow for the capture of multiple feeds which may be viewed by at least one third party historically and/or in real time.

In an embodiment of the present invention, server 740 is local to a third party user. By way of non-limiting example only, user 720 may be utilizing a television equipped to communicate with server 740 and may have the ability to view the information provided via a collection widget correspondent to a browser at user 710. In this way, a minor child browsing the worldwide web on a computer located in a bedroom may have his or her browsing inspected by a parent sitting in a living room watching the television. Such parental inspection may occur at any time during the child's use of the browser, and may occur in real time. Similarly, the parent may program the viewing enabled television to update and/or refresh the third party view of the browsing at a predetermined interval. The information communicated to the parent may also come in the form of an alert. Such an alert may indicate that the browsing has changed locations, such as a change in the root URL, and/or has landed on a URL which has been predetermined to cause an alert to at least one third party.

The viewing by a third party of the tracked browsing may occur on any communication enabled device, such as a mobile phone, wireless computer, and/or a television. It is contemplated in the present invention that even if a television is not directly connected to the internet or otherwise directly enabled to receive information from the tracking widget, such capability may be provided by a third party service provider such as, for example, a cable television operator. For example, such a service provider may be authorized to track the browsing of a particular user and may provide information or an alert, as described above, to an authorized requesting user of the service provider.

In an embodiment of the present invention, at least two distinct tracking widgets may be viewed by a single third party at one time. Such information may be viewed as described above and may be preferably viewed in a split screen format such that the at least two information streams may be visually presented to the third party.

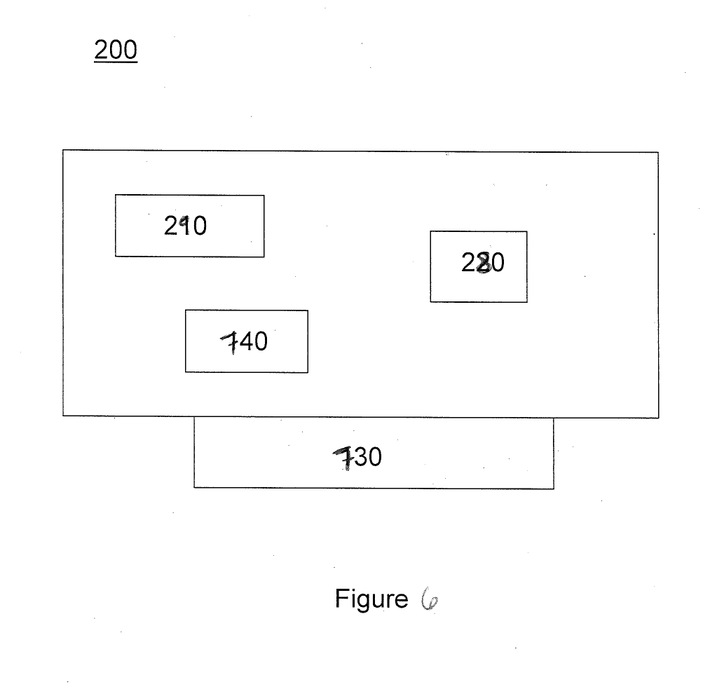

As illustrated in FIGS. 4 and 6, an exemplary network architecture 200 may operate with embodiments of the present invention. The network architecture 200 may include a user device 290, a server 740, an anonymous proxy 280 and a network 730. The user device 290, the server 740 and the anonymous proxy 280 may be coupled to the network 730, which may be a public network (e.g., Internet) or a private network (e.g., an ethernet or a local area Network (LAN)), for example.

In one embodiment, server 740 may be a web server that provides text, images and other information in the form of one or more web pages. The server 740 may accept user requests for content (e.g., hyper text transfer protocol (HTTP) requests) from user device 290, and reply by sending responses (e.g., HTTP responses), which may include information pertaining to web pages.

The user device 290 may be, for example, a personal computer (PC), mobile phone, palm-sized computing device, personal digital assistant (PDA), and the like. The user device 290 may include a browser, as described hereinabove. The browser may be an application that enables the user device 290 to display and interact with text, images, and other information provided by the server 740. In an embodiment of the present invention, the browser may be a web browser configured to display web pages.

A browser may receive user requests for content and send the requests to server 740. In an embodiment of the present invention, a user request for content may be sent to the server 740 to access one or more web pages via the network 730. User requests for content may also be sent to the server 140 to initiate the functionality of the tracking widget. For example, a user request for content may be sent to the server 740 to initiate a tracking function, to obtain browsing information from at least one unique tracking widget.

For example, a user request for content may be sent to server 740 and, may include user identifying information. The user identifying information may be information that may be used to track user browsing behavior, to determine user preferences, and possibly, to ultimately identify a user. In addition to the examples provided above, user identifying information may include an IP address, cookies, and the like.

In an embodiment of the present invention, identifying information may be filtered out, and may be based on a user profile or user preferences. User preferences may include, for example, browsing preferences, search preferences, commerce preferences, and the like. Default user preferences may be provided by the browser if no user preferences are available. Further, a user profile may include user preferences, as well as additional user information, such as user age, for example. In an embodiment of the present invention, a user below a specific age may have associated with them additional context criteria apply. Such information may control, in part, the access provided to third parties with respect to such user profile and/or tracked information.

A user may select the criteria under which to filter out each type of user identifying information. Alternatively, a user may select a privacy setting from multiple privacy settings, each applying different context criteria under different circumstances. Thus, user identifying information may be fully filtered or only partially filtered. For example, when user identifying information is partially filtered, cookies and a referrer header may be filtered out, but an IP address may not be filtered. Some user identifying information can be filtered out simply by not sending the information (e.g., cookies and referrer headers).

In an embodiment of the present invention, the anonymous proxy 280 may be used to filter out user identifying information. If no filtering is being performed, a user request for content may be sent directly to server 740. However, by directly sending a request for content to server 740, the browser may, at a minimum, identify an IP address of the user device 290 to the server 740.

In an embodiment of the present invention, the anonymous proxy 280 may be a proxy server that may act as an intermediate destination to which the user request for content may be forwarded. Alternatively, the anonymous proxy 280 may be a distributed proxy service that includes multiple proxy servers. A user request for content may be forwarded among the multiple proxy servers before being sent to server 740 and may facilitate the receiving by a user of information related to at least two user requests, for example.

In an embodiment of the present invention, the tracking widget may include forwarding logic. The forwarding logic may forward content to the anonymous proxy 280 when directed by a user request. For example, the forwarding logic may forward content to the anonymous proxy 280 when a user request is received from at least one user communicatively connected to the network 730.

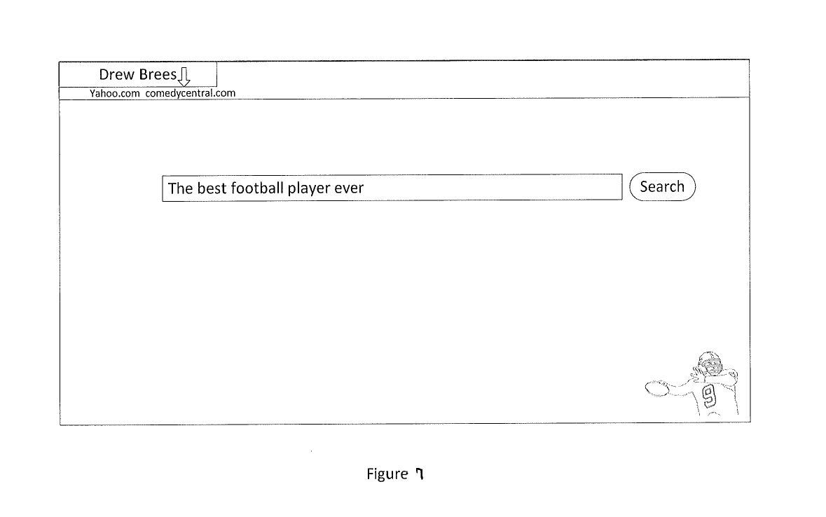

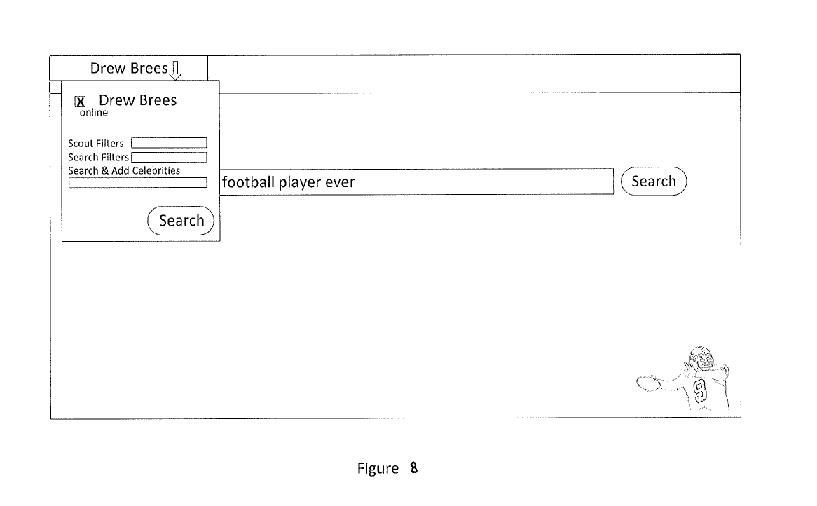

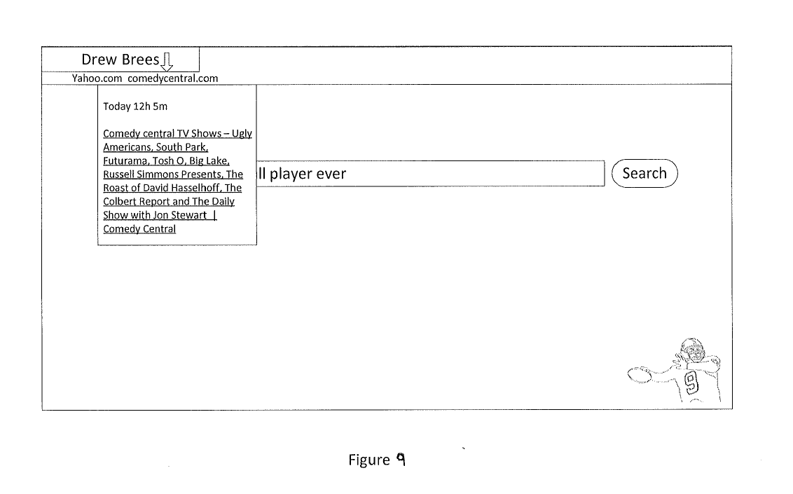

As illustrated in FIG. 7, a graphical user interface (GUI) may be provided by the tracking widget and may include at least one indication that the tracking widget is active. The GUI may also provide at least one source indication related to third party information. For example, and as illustrated in FIG. 8 and FIG. 9, an image representing the source and/or a menu link may be provided.

In an embodiment of the present invention, information created by one user may be syndicated to multiple users of the tracking widget. For example, a tracking widget may provide access to the browsing information of a popular sports athlete to multiple users of the present invention. As described above, the information available to a user of the system may be presented in a variety of ways and may be filtered and/or organized according to various attributes, including, but not limited to, the type of device the information is compatible with, the volume of information available, and the bandwidth required to access the information, and like attributes, for example.

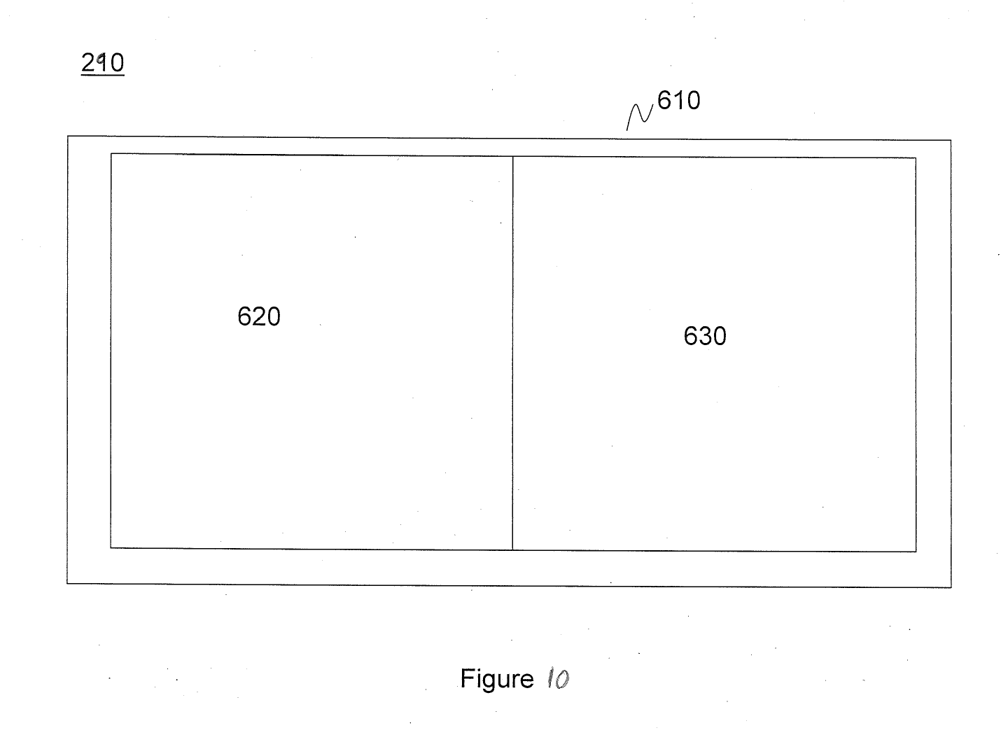

As illustrated in FIG. 10, the GUI may also, as more fully described above, provide access to multiples of information accepted by the user. For example, syndicated information in the form of real-time web browsing by a celebrity may be shown on portion one 620 of the GUI with the historical browsing information related to a related minor child displayed on portion two 630 of the GUI. As would be appreciated by those skilled in the art, the portions may be manipulated, multiplied, and terminated as permitted by the constraints of the device on which the GUI is resident. A celebrity, for the sake of clarity, may be any individual, animal, and/or object familiar to at least 1,000 people during at least one moment in time.

FIG. 10 illustrates an add on/plugin 810, or the like, that may be downloaded by a user in order to allow for the social browsing discussed herein. This plug-in may be downloaded as, for example, an embedded javascript on the second browser that allows for the second browser to be directed by a first browser 710, as referenced hereinthroughout. Correspondingly, the plug-in may sit on any browser and allow that browser to broadcast to, for example, a server 740 as shown in FIG. X1. The server that receives the broadcast may have, by way of non-limiting example, associated therewith at least one database 815 for the tracking of URLs, URIs, and AJAX (user action), events that are performed in the first, i.e., broadcasting, browser. These events are recorded at the direction of the server into the database for eventual broadcast from the server to receiving ones of the second browsers in order to allow those second browsers to engage in the same URLs, URIs, and AJAX as the first browser. As such, a broadcasting first browser 710 may be enabled to receive comments, mark-ups, or the like live via the first browser, and/or via any applications associated with the first browser, and the server may receive this broadcast and either record it for later broadcast to second browsers 720, or broadcast it substantially simultaneously with the receipt of the broadcast by the server in order to enable real time viewing by second browsers.

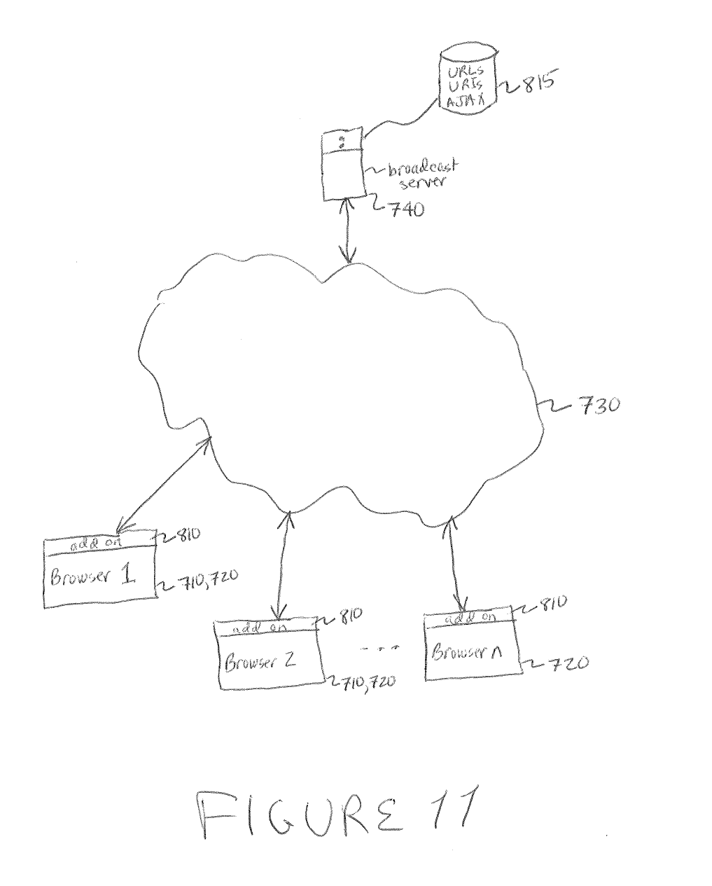

Thus, the database 815 illustrated in FIG. 11 may store social browsing, both as a live series of events, and additionally as a series of content “snap shots”. Thereby, the database may be subsequently searched for a list of broadcasters, events broadcasted, topics of events broadcasted, recipients of broadcasts, and the like. Thereby, the present invention may enable a social browsing conference call of sorts, such as wherein a first browser can actuate a button, such as a “go live” button, grab a series of names off a friend list in Facebook, for example, and can overlay a video chat received at the first browser with the browsing interaction received at the first browser, which combination may be uploaded to the server of FIG. 11 for broadcast to second browsers simultaneously upon broadcast from the first browser. Needless to say, in such an embodiment, each such browser enabled with the present invention may thus alternate in directing the browsing experience of all second browsers, that is, multiple ones of the second browsers may, at certain time periods, serve as the first browser and drive the user experience for the other second browsers. Thus, the present invention provides appreciably more features than, and is interactive in a manner unlike, currently available browsing experiences, such as WebX or Netmeeting. However, in a manner similar to, for example, Netmeeting, the present invention can make available the broadcast from the first browser solely for viewing by a second browser, should the second user choose not to interact with the second browser.

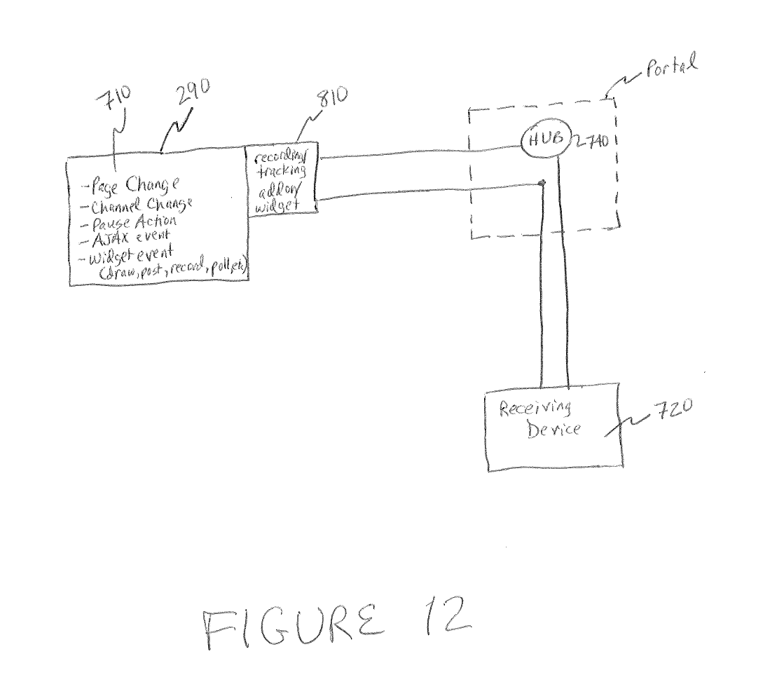

FIG. 12 provides an illustration of an additional and alternative implementation of the present invention. As illustrated in FIG. 12, the present invention may include a first browser 710 that accepts page changes, channel changes, channel stop or pause changes, and AJAX events, and widget events such as drawing, posting, recording audio, video or podcasts, polling, or the like. All such interactions by the first user are received by the first browser and recorded by a widget or the like associated with the first browser, as referenced hereinabove and particularly with respect to FIG. 11. The widget may record, or immediately pass through, the interactions and information received from the first browser. The widget or the like may then broadcast the events, such as to a hub, such as the broadcast server referenced herein in FIG. 11. The hub 740 may, as a recorded broadcast or as a substantially live broadcast, thereafter broadcast the interactions of the first user with the first browser to one or more second browsers 720. In an alternative embodiment, the widget of the first browser may broadcast directly to one or more widgets associated with one or more second browsers. For example, befriending a person in a particular manner on a particular site may enable the person so befriended to broadcast social browsing occurrences directly to one or more second browsers of the persons befriended. Thereby, the present invention may allow for development of a network akin to a peer to peer network, wherein social browsing occurs over such peer to peer network based on permissions of participants in the network, and/or based solely on downloading of the aforementioned plug-in or add on it the form of a widget and/or java script and/or the like.

Thereby, the present invention may allow for a person to invite friends to experience social browsing with that person, and during such social browsing the illustrations of FIGS. 4, 11 and 12 allow that person to embed content 825, such as to ask questions of her friends who are following the social browsing broadcast. Such questions may include, for example, polling questions, such as “am I better looking than Ryan Seacrest?”, wherein the first user directing the first browser could ask such a poll question and further overlay pictures of both the first user and Ryan Seacrest on the underlying site to which the first user was presently directing the first browser.

Further, because the first user can engage the first browser to interact with other applications 830 for providing broadcast content in order to gain content for broadcast, any physical device with a user interface may be used with the present invention. Thereby, a first user can connect friends to any user interface, and modify, enrich, and otherwise broadcast content from the first user's user interface for viewing by recipients of the broadcast on any user interface used by those recipients, and further the first user may share that broadcast in real time with those second users, either substantially synchronously or a synchronously. For example, a user may engage in the poll discussed hereinabove during an underlying television broadcast, and may direct the poll and the overlaid pictures related to the poll to the set top boxes or IPTVs of registered friends of that first user on. Facebook. This is enabled, of course, for any physical device that engages in internet protocol (IP) communications, but may suitably be extended to other non-IP embodiments subject to inclusion of an IP communication normalization engine (not shown) inserted either before or after the broadcast hub in, for example, FIG. 12.

In such embodiments, a widget, or the equivalent for any user interfaceable device, may be associated by the user with a first device, and user interactions may be recorded at that local widget. Thereafter, the user interactions may be sent, directly or through the hub, to the second browsers, i.e., to the second user devices. Needless to say, in such an embodiment, commands may be sent from a typical user devices, such as a smart card, recorded by a widget, and sent on to the smart cards of other users.

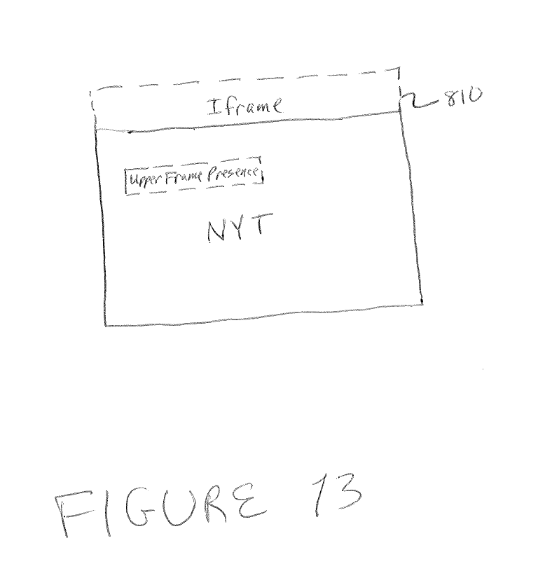

The exemplary widget or like plug-in illustrated with particularity in FIGS. 11 and 12 may perform its recordation and/or broadcast in any of a number of ways. For example, the widget action may be in the form of iFrames, wherein an in line frame, or snap shot, is taken that may indicate another document, and that in any event illustrates whatever is, at that snap shot, resident on the screen of the client device. Alternatively, the widget may perform as discussed hereinabove, namely the widget may record, in real time, all user interactions, such as using embedded java script embedded in a browser. Thus, the widget of the present invention may be a plug-in, add-on, or snap-on, as discussed hereinabove, but may similarly operate not as a plug-in, that is, may be operable without the use of a flash component or the like. More particularly, FIG. 13 illustrates a widget in association with the present invention, wherein a java script iFrame component is recording user position and interactions on a New York Times webpage. Further, the iFrame widget may additionally record ancillary content added by the user engaged in browsing of the New York Times webpage. Such ancillary content may include, for example, content from other applications and/or browser-related applications accessible to the first user, such as DoodlePad, Stamps, or the like. Further, the plug-in may allow for recordation of social browsing sessions, and particular factors thereof, in association with the first, broadcasting, browser, or the second, receiving, browser. Such history may be added in a manner akin to bookmarks or history in presently available browsing environments, and may allow a user to peruse a history of all broadcasts, received broadcasts, or the like. This history may be made available, for example, either from within the local computing system, or may be made available, such as via hyperlink, from the broadcast server or hub that receives and/or sends such broadcasts to each individual user.

Thus, in an exemplary embodiment, responsive to the javascript component and the site indicated by the first browser, the widget associated with the second browser may indicate the second browser locate to the site. The addon may not only include the javascript and the widget, but may additionally provide a visual cue that a favored celebrity is currently online, for example, such as the topline interface discussed above. When the cue appears, the user can invoke the add-on to allow the user to participate in the social browsing experience via the javascript and widget.

Addon applications in accordance with the herein described systems and methods may be installed on a plurality of a particular user's computing terminals. For example, a user may have a PC, a tablet computer, and a smart phone, each with its own web browser, and addons may be installed on each device. In that event, information specific to the user on one device may be made accessible to, propagated to, and/or be synchronized with one or both of the other devices, using methods known in the pertinent arts.

In an exemplary implementation, an online broadcaster, such as a teacher for example, may broadcast a web session, such as an educational session, that may be accessed by any and all users, or may broadcast only to designated users such as registered members of a class. Such a session may include a broadcasted web browsing session, combined with audio and/or video, such as a teacher commenting or lecturing on the web browsing. Users such as students may view the browsing session, which may be replicated within their own browsers running on their local computing terminals. In an embodiment, the users/viewers may take part in an interactive session. Various types or classes of users may be granted various degrees of interactivity. The interactivity may be between the broadcaster and one or more users; or between two or more users, or both. Access to some or all interactive functions may require user identification, authentication, and/or authorization to participate. The interactivity may be governed by permissions, for example, in which different participants or groups of participants may be granted different levels of access or interactive functionality. There may be more than one broadcaster, for example, a plurality of presenters in a panel discussion to a user audience. Users may be granted the ability to broadcast as well, for example, to ask the panel questions, so that only a select one or more panel members, or all panel members, or the panel plus all users, or just the user community but not the panel, may see and/or hear the broadcasting user. In this way, any or all of the viewers may actively participate in, rather than just view, the session. In addition, a first user may share his own browsing experience with one or more of the others, so that the first user's browsing session may be replicated on others' computing terminals, and/or vice versa.

In an additional illustrative scenario, a live feed news network anchor may alternate during a newscast between a web camera/microphone and a plurality of live feeds and/or internet browsing sessions, occurring in real time or previously recorded, on one or more computing terminals. The anchor may delegate host rights to another, so that the other may broadcast to the viewers in the same manner, such as from a location relevant to a breaking story. The handoffs may be controlled by the anchor or by another party, such as a producer or support staff. The broadcast may be recorded and stored in a network server, or recorded locally by a user/viewer. The viewer may then re-watch the broadcast. The viewer may also pause a live or recorded viewing session, conference in one or more friends whose computing terminals have installed the required addons and are configured to participate, and return to the viewing session which is then shared among the conference participants. The viewing session may be replicated on the terminals of the participants, who may also share comments among themselves, and/or conference in further participants.

In another illustrative scenario, a joint production can be composited from a plurality of computer sources in real time. The contributors of the content may be located at any convenient location, but the composite may be arranged to appear to a viewer like a unified, single point broadcast. In an implementation, to conserve bandwidth minor changes to a page may not be propagated to viewer terminals, but more substantive changes, such as changes to 10% or more of a viewing area, may be broadcast to viewers. Such an approach appears to viewers as a current, live page view that may be interacted with.

In yet another illustrative scenario, a known broadcasting personality, such as a radio program host, may broadcast a daily radio show over the internet in an audio only broadcast. In conjunction with the broadcast, select information related to the host, constituting a host “persona,” may be injected into one or more web sites, which may be viewable only by users that have downloaded a select host-specific addon application, for example. Persons affiliated with the radio host, such as a program director, may provide customized subject matter for overlay on select websites during select portions of the broadcast. For example, when the subject of the broadcast turns to politics, one or more politically relevant websites, such as the sites of the President and Congress, may display matter related to the broadcast, during that portion of the broadcast. The overlaid subject matter and target web pages can be coordinated in time with the radio broadcast, such as by the aforementioned broadcast server, to provide a unified listener/viewer experience. The whole broadcast, including live chats, may be recorded locally and/or remotely and stored, so that a user may go back and watch any or all of the broadcast.

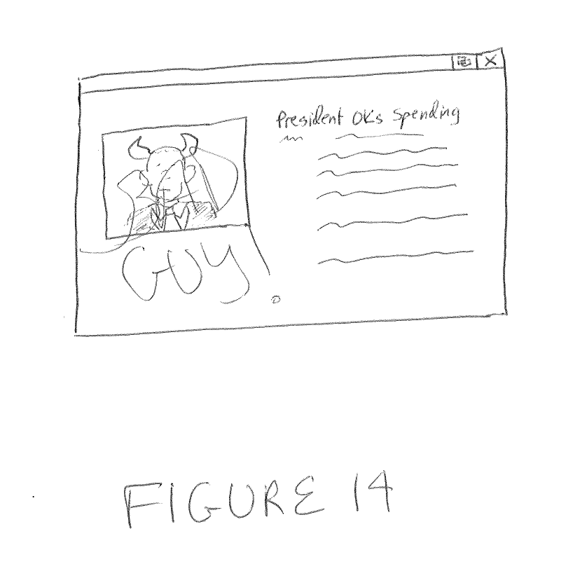

In this illustrative scenario, the radio host may also broadcast a trail of Facebook pages and/or tweets, may talk with Facebook friends, live chat during the broadcast, etc. Further, in this exemplary embodiment, the radio host may broadcast in audio only, or video and audio mode, for example, and may do so in conjunction with the program director and an ad manager, for example. The radio host's audio or video and audio may be broadcast while the host and/or the program director engage in the broadcast of the social browsing engaged in by the host. More particularly, for example, the radio host may discuss the President of the United States, and the program may browse to a website regarding an amusing picture of the President, or to a website illustrating the President and upon which the program director uses an application to overlay a photo of the President on which is drawn horns and the label of a “Really, Really Bad Guy.” Such an embodiment is illustrated in FIG. 14.

Moreover, recipients of the broadcast can engage in underlying web based activities while still receiving the broadcast, such as engaging in live chatting, surfing to other webpages, or the like while leaving the broadcast webpages. In an exemplary embodiment, upon leaving the social browsing broadcast, the user may be provided with a user-actuated button that may say, for example, “Rejoin Broadcast”, wherefrom the user can return to the radio host's social browsing broadcast, either at the point of departure or at the point at which the user rejoins the live social browsing broadcast.

In addition, the radio host may broadcast to listener/viewers a browsing session of his own or of an affiliate. The host may present poll questions to listener/viewers and generate associated intelligence in real time. The host may thereby adjust his approach during the radio broadcast to be responsive to feedback of the listening audience delivered to him in real time.

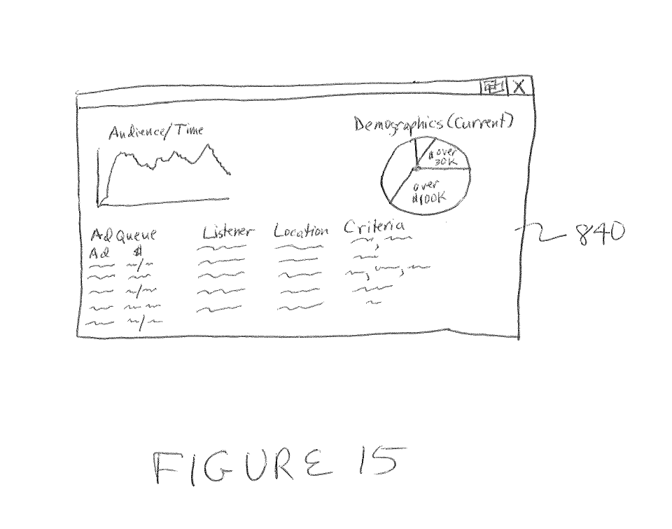

The host may be presented with a browser-related “dashboard” 840 application or the like, presenting a list of select or all listeners/viewers, which list may receive information from the widgets/javascript associated with each of the second browsers viewing the radio host's social browsing. Preferably, the list may be sortable by one or more criteria. The host may then choose a listed listener based, e.g., on demographics, invite that listener to participate in a live chat and/or live video cast that may be overlaid on a browser while second users may navigate from page to page on the web in the second browsers. The host's dashboard, i.e., the first browser, may be such as is illustrated in FIG. 15.

The radio host's dashboard of information received via the browser plug-ins, for example, of receiving users of second browsers, may indicate to the program manager and/or advertising director, such as in real time during the broadcast, that Mercedes Benz has offered to place an advertisement for $1,200 for ten seconds. The dashboard may illustrate all offered advertising values during particular time periods, and thereby may allow the advertising director to pick the most lucrative advertisements for placement at various points during the broadcast. Similarly, because the dashboard may illustrate the demographics, the advertising director may recognize that a Mercedes Benz advertisement, or a product placement reference to Mercedes Benz, may be requested by Mercedes Benz when the demographic mix of listeners reaches a certain criteria, such as 1,200 listeners having an annual income greater than $500,000. In such an embodiment, Mercedes Benz may, needless to say, pay a premium for placement of its advertisement when listenership reaches the requested criteria.

Further, because the present invention includes the social browsing session, an audio advertisement during the broadcast from Mercedes Benz can also take all 1.2 million listeners of a radio program to the Mercedes Benz webpage, that is, because the page for Mercedes Benz isn't streamed with the audio, all broadcast recipients may be taken to the live webpage whereby, if a particular user clicks on the webpage, the user may be enabled to research Mercedes Benz, or make purchases related to Mercedes Benz, just as the user would if the user had initially gone to the Mercedes Benz website. Further, if the user attempts to leave the broadcast, the user maybe provided with a message that says “you are about to leave the broadcast, please click the icon at the lower right to return to the broadcast at your convenience.” As such, advertisements during, for example, radio or audio video broadcasts may, through the use of the present invention, further include delivery of the recipients of the broadcast directly to the webpage of the advertiser placing the advertisement.

Thereby, one or more ads may be delivered in accordance with the addon to listeners/viewers during such a broadcast. The value and/or revenue generated by the ad may be determined based on measurements made during the broadcast. For example, a dashboard may be provided to the broadcast producer that provides information of listeners at the time ads are presented. The dashboard may automatically calculate and display revenues generated by each ad during the broadcast, and/or keep a running total of revenue generated. In addition, ads may glean information directly from material made accessible online by the sponsor, and can be linked to the ad, or broadcast to listeners, the focus of web browsers of listeners may be directed to an addon application viewable area displaying sponsor information, or to a web page of the sponsor launched as the base web page, or in its own tab or window, in response to the ad running during the broadcast. In this matter, the radio show ad can cause web traffic to be directed to the sponsor's web page.

In summary, the addon can thus enable a user to participate in an interactive, social browsing web session, such as by commenting, marking up and rebroadcasting, recording and playback of the session, or by receiving any of the above, for example. The user may take and use a screenshot or the like during a broadcast. The user may obtain and search a list of the recipients of his broadcast. The user can invite other online users to participate in the session, such as by selecting them from a list and using the addon-provided “go live” button or the like. The invited users may then choose to participate in a chat, such as a text, audio, and/or video chat, while the broadcaster broadcasts data that replicates his browsing session on the participating users' terminals. The data may be broadcast directly to the participants, or may be sent to a network server, which receives the data and broadcasts it to the participants. Browsing session control may be passed among the participants, whereby a select one of the participants becomes the broadcaster and the others viewer/participants. Thereby, all participants may effectively have a shared browsing/conferencing experience not possible in the prior art, which is initiated using a straightforward point-and-click interface. Any type of computing terminal that can support a web browser or other web-enabled user interface, can be enhanced or natively developed to join such a session/conference, enrich content for participants, share in real time and/or asynchronously such as by recording and storing session data, either locally or remotely.

In another illustrative scenario, the herein disclosed systems and methods provide a commerce engine for celebrities and the like. An event or program may be broadcast live, or recorded for later editing and broadcast. For example, a camera crew with a web-enabled camera may trail the celebrity while shopping. Items viewed during the shopping trip may be displayed and identified in browser enhancements for viewing by users during the broadcast. Selecting a displayed item may launch a web-based storefront webpage in its own tab or window, with which the user can obtain more information and/or purchase the selected item. Viewers can be engaged by presenting polls, by selecting individuals to participate in live chats, etc. Subject matter relevant to the broadcast may be pre-recorded and presented during the broadcast. For example, a celebrity can try on various items of clothing and poll viewers to determine their favorites, etc. By pre-selecting material that will be broadcasted, the broadcast can be made to appeal to different viewer segments. For example, a celebrity shopping for cars may appeal to men 18-45, while a different celebrity shopping for shoes may appeal to women 18-45.

By way of particular example, as a celebrity shops, the web pages corresponding to the brick and mortar stores in which the celebrity shops may be cued, such as from a previously recorded browsing session, but the social browsing session may be “played” to correspond with a timed social browsing event, such as to which users are invited via the Twitter page of the particular shopping celebrity. Thereby, the actual shopping session of the celebrity may be live, and may be overlaid on the recorded social browsing session, or the shopping experience of the celebrity may be recorded in video for playback along with the social browsing session.

A well-known female celebrity may invite followers on a particular website to go shopping with her on a Saturday morning at a well-known brick and mortar store, such as Victoria Secret. A video celebrity shopping at the store may be played during the shopping experience for the viewing users, and likewise the web page of Victoria Secret, or deep links to aspects thereto, may be displayed for the users relevant to each item that the female celebrity tries on in the video. Users may be polled through the social browsing overlay experience as to which items the users wish the celebrity to select.

Further, modifications to content may be injected, such as by the producer of the web page and/or by the social browsing broadcast, such as injecting content onto the URL of a discount on the particular item then being shopped for by the celebrity for all viewing users if the viewing users make a purchase from the underlying web page then in view before the celebrity leaves the web page in the social browsing experience. Similarly, viewing users may get a significant discount on all items available through the advertised web page if the users make purchases from the web page while viewing the social browsing experience. Needless to say, such a discount may serve the offer or of the discount well, in part because the group discounts so granted should more than be made up for by the number of users landing on the store's web page.

Moreover, ads may be presented during the broadcast, as described previously. The ads can include discounts that are good for a defined period, such as for the duration of the celebrity broadcast, as, discussed above. Alternatively, discount coupons may be provided, either by a link or directly during a broadcast, for use in a later purchase. The discount coupon may be of a kind that may be used in an online purchase, or that may be printed and used in a physical store.

Revenue associated with the broadcast may be generated based on identified viewer purchases made online during the broadcast or within a certain time after the broadcast, and/or views by identified viewers of ads delivered during the broadcast, etc. Revenue may be generated from purchasers and/or from sponsors, and may be distributed to various involved parties such as the celebrity, his agent, the broadcast producer, the technical framework operator, etc.

Those skilled in the art wilt appreciate in light of the disclosure herein, that the claimed invention is thus highly useful to all parties in the aforementioned social browsing transaction. For example, the advertiser can obtain new advertising inventory by placement of the enhanced media. By way of further example, the site provider may incur additional rich media that may be placed on the site without cost to the site provider, and that, in fact, may provide additional revenue to the site provider. Such rich media, due to the use of a widget in the present invention, may include, the widgetization of desirable content, such as the flipping of Getty images like trading cards, with statistical information on the back of trading card, for example. Finally, the present invention proves useful to the subject of interest in the enhanced media, particularly in embodiments wherein an advertisement for which the subject of interest is an endorser is provided. From the provision of the endorsed advertisement, the subject of interest generates revenue when a user acts on the advertisement.

In an additional exemplary embodiment, a college professor may, for example, travel across the web while adding commentary regarding articles in the Wall Street Journal, Al Jazeera, or the like, with respect to current events in the world at that time. Viewers corresponding to such social browsing by the college professor may need access permission to follow the professor, which may, for example, be a user name and password associated with the viewer being a student of that professor. The perspective thereby imparted by the professor in such a social browsing embodiment, such as the aforementioned private social browsing embodiment, is far beyond that presently available in, for example, the realm of blogging.

In order to encourage viral propagation of the herein disclosed systems and methods among users, current users and participating celebrities may publish to their Facebook pages, tweets, and/or other web-based resources “teaser” content that references further “enhanced” online content that requires the installation of one or more of the hereindescribed addons to be fully enabled, along with a link to download the required addons. Alternatively, the link may be to the enhanced content itself, and the required addons may be downloaded and installed automatically to a user's computing terminal when the user clicks on the link to the enhanced content. The teaser content may be generated by a teaser publisher using a separate or reduced-capability “light” addon. The light addon inserts into the publisher-generated messages or other content the link needed by the message recipient to download one or more addons that provide the functionality described in the foregoing.

Although the invention in its various aspects has been described and illustrated in a variety of exemplary forms with a certain degree of particularity, the herein described exemplary forms have been made by way of example and not by way of limitation. Those of skill in the relevant arts will recognize in view of the instant disclosure that numerous changes in the details of construction and combination and arrangement of parts and steps may be made without departing from the spirit and scope of the invention, which is defined in the claims. Thus, it is intended that the present invention cover modifications and variations of the herein disclosed systems and methods provided they come within the scope of the appended claims and their equivalents.

What is claimed is:

1. A system for providing a browsing widget, comprising:
a javascript component that, upon execution, obtains at least primary content on a networked page, and at least one permission regarding the primary content; and
a browsing widget for receiving browsing content produced remotely from said javascript component and forwarded over at least one network to said javascript component, wherein receipt of said browsing content by said javascript component modifies at least the primary content pursuant to the at least one permission.

2. A system for monitoring internet activity, comprising:
a first tracking widget communicatively coupled with a first browser comprising at least one computerized memory communicatively associated with at least one processor programmed to provide browsing information from the first browser to at least one collection point,
at least one second tracking widget communicatively coupled with at least, one second browser comprising at least one computerized memory communicatively associated with at least one processor programmed to receive browsing information from the at least one collection point;
wherein the information provided by the first tracking widget allows the at least one second browser to display the information as displayed by the first browser.

3. A topline access interface, comprising:
at least one widget communicatively coupled with at least one browser associated with at least one processor, programmed to receive browsing information from a browsing point;
a topline access interface to said at least one widget, wherein the browsing information provided by the browsing point is interactively displayed in the at least one browser pursuant to said at least one widget responsive to accessing said topline access interface.

4. The interface of claim 3, wherein said at least one widget comprises a plug-in.

5. The interface of claim 3, wherein the browsing information is real-time.

6. The interface of claim 3, wherein the browsing information comprises a pre-recorded playback

7. The interface of claim 3, wherein said topline access interface comprises an indication of generation of the browsing information by the browsing point.

8. The interface of claim 7, wherein the indication comprises a ticker.

9. A web browsing system, comprising:
at least one browsing server capable of accessing a plurality of content, including a plurality of web pages;
a first user interface executed by at least one processor and in communication with said browsing server, wherein said first user interface is capable of accessing ones of the plurality of web pages, and layering thereon ones of the plurality of content, in a single display window; and
a computing component associated with a user browser and capable of directing the user browser to the ones of the plurality of web pages, upon direction from said at least one browsing server and responsive to the accessing by said first user interface, wherein a single display of the ones of the plurality of web pages on the user browser comprises at least interactive ones for a user of the user browser of the ones of the plurality of web pages, and the layered thereon ones of the plurality of content.

10. A web browser, comprising:
a communicative connection to at least one browsing server capable of accessing a plurality of web pages;
a first user interface connected to the at least one browsing server via the communicative connection, and capable of accessing ones of the plurality of web pages; and
a java component associated with at least one remote browser that effectuates browsing by the at least one remote browser responsively to said first user interface, and that is, substantially simultaneously to the effectuation of the browsing, capable of executing on the at least one remote browser of a response to at least one web-based command entered to the at least one remote browser.

11. A remotely directed browsing web system, comprising:
a first user interface directed by a first user and capable of directing, via a packetized computing network, at least one remote browser capable of direction by a second user, wherein said first user interface is suitable for accessing a plurality of web pages; and
an embedded component associated with the at least one remote browser that directs the at least one remote browser to ones of the web pages responsively to the directing of said first user interface, and that allows, within a single display of the at least one remote browser, entry of at least one page command to the ones of the web page by the second user to direct the at least one remote browser;
wherein said embedded component provides at least tracking of the at least one page command to said first user interface during the directing by the first user.

12. A browser-based local and remote web browsing system, comprising:
at least one browsing server capable of accessing a plurality of web pages and capable of synchronously recording the access to the plurality of web pages;
a first user interface communicatively connected to the at least one browsing server and capable of directing the accessing of ones of the plurality of web pages; and
an embedded java component associated with at least one remote browser and communicatively connected to said at least one browsing server that locally effectuates the previously synchronously recorded browsing by said first user interface on the at least one remote browser, and that is responsive to directions entered to the at least one remote browser during the previously synchronously recorded browsing on the at least one remote browser.

13. The system of claim 12, wherein the synchronously recording comprises a recording of universal resource locators of the plurality of web pages.

14. The system of claim 12, wherein the synchronously recording comprises a recording of a then-current display of the plurality of web pages.

15. An online advertising system, comprising:
a communicative connection to at least one browsing server capable of accessing a plurality of web pages;
a first user interface connected to the at least one browsing server via the communicative connection, and capable of accessing ones of the plurality of web pages;
an embedded component associated with at least one remote browser that directs browsing of the plurality of web pages by the at least one remote browser responsively to said first user interface, and that is substantially simultaneously capable of response to at least one direction entered to the at least one remote browser; and
at least one advertising server that produces advertisements on the plurality of web pages during the responsive browsing by the at least one remote browser, wherein a rate for the produced advertisements is correspondent to a number of the at least one remote browsers responsively browsing upon serving of the produced advertisements.

16. An online advertising charging system, comprising:
a first user interface connected to at least one browsing server via a communicative connection, and capable of accessing ones of the plurality of web pages;
an embedded computing component associated with at least one remote browser that directs browsing of the plurality of web pages by the at least one remote browser responsively to said first user interface, and that is simultaneously capable of response to at least one direction entered to the at least one remote browser; and
at least one advertising server that monitors an owner of each of the plurality of web pages during the responsive browsing by the at least one remote browser, wherein an advertising rate is charged to each of the owners correspondent to a number of the at least one remote browsers responsively browsing to the owner's one of the plurality of web pages.

17. A local and remotely directed browsing system, comprising:
a first user interface directed by a first user and capable of directing, via a packetized computing network, at least one remote browser capable of direction by a second user, wherein said first user interface is suitable for accessing a plurality of web pages, and wherein said first user interface is further capable of directing an overlay of media content on the accessed ones of the plurality of web pages;
an embedded component associated with the at least one remote browser that directs the at least one remote browser to ones of the web pages responsively to the directing of said first user interface, and that substantially simultaneously allows entry of at least one page data entry by the second user to direct the at least one remote browser.

18. The system of claim 17, wherein the at least page one data entry comprises a response to the overlay of media content.

19. A browsing system, comprising:
a first user interface directed by a first user and capable of directing, via a packetized computing network, at least one remote browser capable of direction by a second user, wherein said first user interface is suitable for accessing a plurality of web pages, and wherein said first user interface is further capable of providing non-page content in relation to the accessed ones of the plurality of web pages;
a java component associated with the at least one remote browser that, in a single window, directs the at least one remote browser to ones of the web pages responsively to the directing of said first user interface, allows entry of at least one page command by the second user to direct the at least one remote browser, and allows an injecting of the provided non-page content on a displayed one of the plurality of web pages.

20. The system of claim 19, wherein the non-page content comprises a discount coupon solely to responsively browsing ones of the at least one remote browser.

21. A local browsing tracker and remote browsing director, comprising:
at least one computer memory to which is recorded, by at least one computing widget, at least changes made by a first user in browsing location, and user interaction by the first user with the browsing location;
at least one telecommunications network;
a plurality of client devices, wherein said plurality of client devices receive at least the recording from said at least one computer memory, and wherein said plurality of client devices are capable of interacting with the browsing location from within a window in which is displayed at least the changes made by the first user.

22. The local browsing tracker and remote browsing director of claim 21, further comprising a hub, wherein said hub is interstitial to said at least one telecommunications network, and wherein said hub at least partially records the interacting of said plurality of client devices.
